(19) United States
(12) Patent Application Publication
(10) Pub. No.: US 2006/0131228 A1
(43) Pub. Date: Jun. 22, 2006

(54) Filtration assembly for mixing faucet

(76) Inventor: David Truong, Sydney (AU)

Correspondence Address: Sankoson Lawyers, P O Box K1011, Haymarket NSW 1240, Sydney Australia, AU

(21) Appl. No.: 10/559,968

(22) PCT Filed: Jul. 6, 2004
(86) PCT No.: PCT/AU04/00888

§ 371 Date: Dec. 8, 2005

(30) Foreign Application Priority Data
Jul. 8, 2003 (AU) 2003903518

(51) Int. Cl. B01D 35/00

(52) U.S. Cl. 210/449; 210/459; 137/603; 137/801

(57) ABSTRACT

An assembly (1) enabling filtration of mixed hot and cold water; the assembly including A faucet (2) capable of receiving hot and cold water and discharging mixed hot and cold water through an outlet (7a) in the faucet, control means (6) for operating the faucet; a filter assembly (11) adapted for insertion in a water supply line in which water to be filtered flows; at least a first conduit (4,5) having a supply of water and in communication with a mixing chamber (9) disposed in the faucet; a first outlet line (10) from said mixing chamber (9) communicating with the filter assembly; an outlet line from said filter assembly (11) communicating with said mixing faucet (2); wherein mixed water exiting from the mixing chamber (9) is filtered by the filter assembly (11) upstream of said faucet and prior to discharge of mixed water from the outlet of the faucet.

### BACKGROUND

The present invention relates to mixing faucets and more particularly relates to a mixing assembly in which hot and or cold water are filtered before discharge from a faucet outlet orifice. The present invention further relates to an assembly which allows mixing of hot and cold water in addition to filtration of mixed water prior to discharge from an outlet orifice.

### PRIOR ART

There are in existence a wide variety of tap and faucet fittings in which water is delivered mixed or through separate outlets. There are generally two classes of such fittings the first of which is a pillar tap which delivers either a single stream of either hot or cold water or a single stream of mixed hot and cold water. The second type of fitting category are those which have separate upstream spindles but allow down stream mixing before discharge from a goose neck fitting or the like.

The prior art also teaches the use of water purifiers in conjunction with water supply tap assemblies but these purifiers are usually placed in line upstream of the outlet and in either a cold or hot water line water line. Traditionally each water stream is filtered separately but this arrangement is costly as two filters are required.

A mixing faucet with a water purifier of this kind is proposed in Japanese Patent Laid-Open No. 210287/1992, Specifically, this mixing faucet with a water purifier is so constructed that a spout is provided to a lower portion of a faucet body. A purifier cartridge container is provided above the same and a valve and a lever are provided in the portion opposed to a purifier cartridge container along with a purified water spout above the valve and the lever. Of these, the valve adjusts the flow rates and mixing of cold water and hot water and opens and closes the passage leading to the purifier cartridge container, and the lever is for operating the valve.

In such a conventional mixing faucet with a water purifier as described above, however, not only is there a valve mechanism for opening and closing the passage leading to the purifier cartridge container but also another valve mechanism, which is so frequently operated for adjusting the flow rates and mixing of cold water and hot water that it is liable to fail. The valves are integrally assembled and the valve functioning part and the purifier cartridge container are united with the faucet body, and the entire faucet body has to be replaced if the valve functioning part becomes faulty.

As a result, this mixing faucet has a problem of poor economical efficiency. As described above, not only the valve mechanism for opening and closing the passage leading to the purifier cartridge container, but also the valve mechanism, which is so frequently operated for adjusting the flow rates and mixing of the cold water and the hot water that it is liable to fail, are integrally assembled with the valve functioning part. Moreover, these valve mechanisms and valve functioning part are integrated with the faucet body, and this integral structure is further integrated with the spout assembly. Since in this arrangement, the purifier cartridge container is attached to the faucet body above the spout lead-out portion of the faucet body, it is located at such a high position that it is conspicuous, spoils the design balance of the entire mixing faucet and obstructs the dish washing work in the sink and/or the work of placing kitchen gadgets at the back of the sink

U.S. Pat. No. 5,705,067 discloses a Mixing faucet with water purifier. A body is constructed by mounting a purifier cartridge in a cold-water passage and is equipped with a purified water handle for opening and closing a branch passage leading from the cold-water passage to the purifier cartridge. To this body, there is mounted a base which includes a valve functioning part for adjusting the mixing of cold water and hot water coming through the cold-water passage and a hot-water passage, and the flow rates of the cold water, the hot water and the mixed water by operating a lever. A spout spouts therefrom the cold water, the hot water, their mixed water adjusted by the valve functioning part, or the purified water. The purified water handle and the valve functioning part are provided separately, and hence they can be individually replaced when they fail. The valve functioning part and the base can be commonly used with the corresponding parts of an ordinary mixing faucet and can be operated independently of each other to improve their operability.

U.S. Pat. No. 5,983,938 discloses a combination faucet assembly and filter assembly wherein these respective assemblies are interconnected in a side-by-side relationship by pipes preferably located in a common housing structure. The combination is adapted for use in association with a kitchen sink or the like. The faucet assembly incorporates a valve for mixing hot and cold tap water and for diverting cold tap water for passage through a filter in the filter assembly. A spout is preferably associated with the faucet assembly. A pivotable faucet lever is preferably associated with the faucet assembly. The lever has a universal type of movement capability and is manipulated by an operator to accomplish regulating of either such mixing of such diverting, and also the regulating of water volume issuing from the spout. Preferably, in mixing hot and cold in an operator selected ratio are fed to a mixing chamber adjacent the valve before dispensing of the resulting water mixture from a spout. Preferably, in diverting, the faucet lever is moved downward below the normal off position whereby cold water is diverted from the faucet assembly, passes through the filter, returns to the faucet assembly and exits through the spout. Preferably, the filter is in a cartridge form that is insertable into and removable from the filter assembly through the top thereof Preferably the spout has one channel for mixed water and another channel for filtered water.

Thus although the prior art teaches the use of a filter in conjunction with tap assemblies irrespective of whether they are capable of mixing hot and cold water or not, the prior art in fact teaches away from the combination of a purifier filter used to filter mixed hot and cold water before discharge from a tap outlet

### INVENTION

The present invention provides an assembly in which mixed water is filtered prior to discharge from a discharge orifice.

More particularly the present invention provides a water reticulation network which includes an in line filter which enables filtration of at least two mixed water streams.

The invention according to one form comprises a combined assembly including a mixing faucet, an in line filter means, at least first and second conduit means terminating in a mixing chamber, a first outlet line from said mixing chamber interconnecting said filter means, an outlet line from said filter means communicating with said faucet means.

According to a preferred embodiment the faucet includes a mounting means which allows the faucet to be affixed to a rear deck of a sink according to conventional means. The faucet includes a spout for dispensing mixed and filtered water from an orifice.

The faucet includes a chamber which receives at least two separate water lines. Preferably there are two lines one hot water and the other cold water. The mixer tap may either dispense cold or hot water or a mixture of both which allows in one assembly filtration of cold, hot or a mixture of cold and hot water.

The assembly according to the invention allows water in transit to the faucet to be filtered in a mixed state while retaining the capacity to filter either hot or cold water all with one filter.

Preferably an output from a mixing chamber communicates with an in line filter so that mixed hot and cold water can pass through the filter before delivery to an out let of the faucet

A valve allows the capacity in the faucet to switch between hot and cold water or to mix hot and cold water. The valve has a valve body which may define an input channel means for receiving each of said hot water and said cold water.

Preferably the in line filter will typically comprise a filter housing and a filter cartridge inside the housing. The faucet means is adapted for conveyance of filtered water from an outlet of the filter to the spout means. The filter cartridge is replaceable in the usual manner.

According to one embodiment the combined filter and faucet assembly includes a single adjustable valve means, a single valve means adjusting lever means, dispensing spout means for dispensing tap water, output conduit means for delivering mixed water streams wherein the filter is preferably interposed between a mixing chamber and the spout.

The filter also has a housing, and a removable housing end cap means for inserting and replacing a filter cartridge means in said housing. According to one embodiment, two filters may be used in series in the line which carries mixed water.

In another broad form the present invention comprises:

an assembly enabling filtration of mixed hot and cold water; the assembly including;

a faucet capable of receiving hot and cold water and discharging mixed hot and cold water through an outlet in the faucet,

control means for operating the faucet;

a filter assembly adapted for insertion in a water supply line in which water to be filtered flows;

at least a first conduit having a supply of water and in communication with a mixing chamber disposed in said faucet,

a first outlet line from said mixing chamber communicating with the filter assembly and which delivers mixed water to said filter assembly,

an outlet line from said filter assembly communicating with said mixing faucet;

wherein mixed water exiting from the mixing chamber is filtered by said filter assembly upstream of said faucet and prior to discharge of mixed water from said outlet of said faucet.

In its broadest form the present invention comprises:

a mixing faucet and filter arrangement, comprising:

a faucet body having a mixing chamber capable of receiving cold water and hot water therein, said body having a lower end which receives at least two inlet lines in communication with the chamber;

at least one outlet line from the mixing chamber in communication with at least one filter assembly disposed in the outlet line; wherein water mixed in the mixing chamber passes through the at least one filter.

According to one embodiment, there are multiple outlet lines carrying mixed hot and cold water emanating from the mixing chamber.

In another broad form of method aspect the present invention comprises:

A method of filtering water delivered to a mixing faucet in a filtering assembly, the assembly including a mixing faucet a faucet body having a mixing chamber capable of receiving cold water and hot water therein, said body having a lower end which receives at least two inlet lines in communication with the chamber;

an outlet line from the mixing chamber in communication with at least one filter assembly disposed in the outlet line; wherein water mixed in the mixing chamber passes through the at least one filter;

the method comprising the steps of

a) placing at least one filter in a water supply line capable of delivering mixed hot and cold water from the mixing chamber of the faucet;

b) allowing mixed hot and cold water to pass through the filter so that water passing through the filter is hot and/or cold water so that any water discharged from the faucet is filtered.

In another broad form of a method aspect the present invention comprises:

A method of filtering water delivered to a mixing faucet from a water supply, using an assembly including a mixing faucet having a faucet and a mixing chamber capable of receiving cold and hot water therein, said faucet body having a lower end which receives at least two inlet lines in communication with the mixing chamber and which deliver water to the chamber;

the method comprising the steps of:

a) taking at least one filter assembly and placing the at least one filter assembly in a water supply line capable of delivering mixed hot and cold water from the mixing chamber of the faucet;

b) allowing water mixed in said mixing chamber to pass through the at least one filter assembly;

c) allowing mixed hot and cold water to exit the at least one filter assembly so that water passing through the filter is hot and/or cold water so that any water discharged from the faucet is filtered.

The filter is held in a housing having a detachable lid to enable replacement of filter cartridges. Preferably the mixing faucet is located above the filter assembly.

Filters may be placed in series depending upon the level of filtration required

Typically, the faucet will be mounted on a sink in the usual manner. Hot and cold inlet water pipes will enter at a base of the faucet terminating in a mixing chamber. An outlet from the mixing chamber carries mixed water to an outlet the faucet but via at least one in line filter assembly which is preferably mounted under the sink The available water pressure will enable the mixed water to negotiate the filter upstream of discharge via the faucet outlet

### DETAILED DESCRIPTION

The present invention will now be described in more detail according to a preferred but non limiting embodiment and with reference to the accompanying illustrations, wherein:

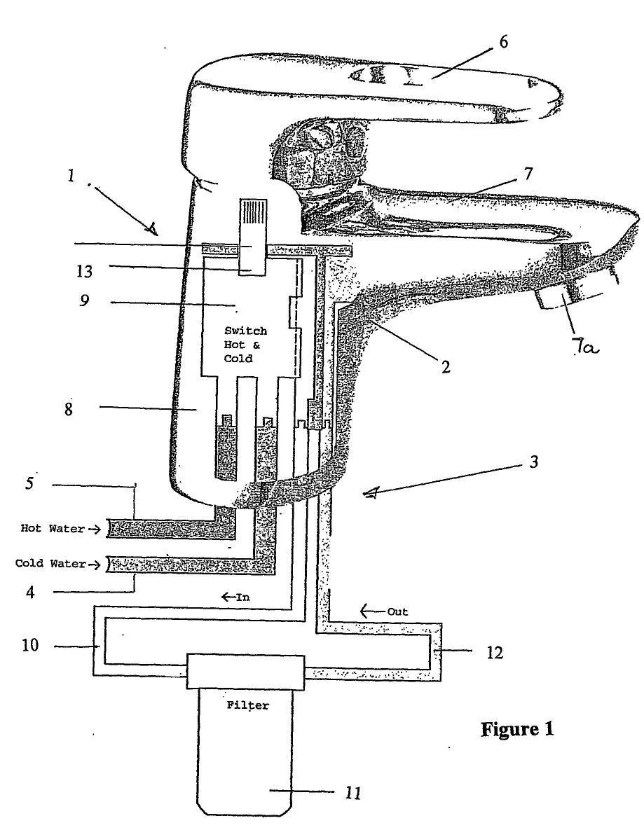

FIG. 1 shows a schematic view of a filtration assembly according to a preferred embodiment.

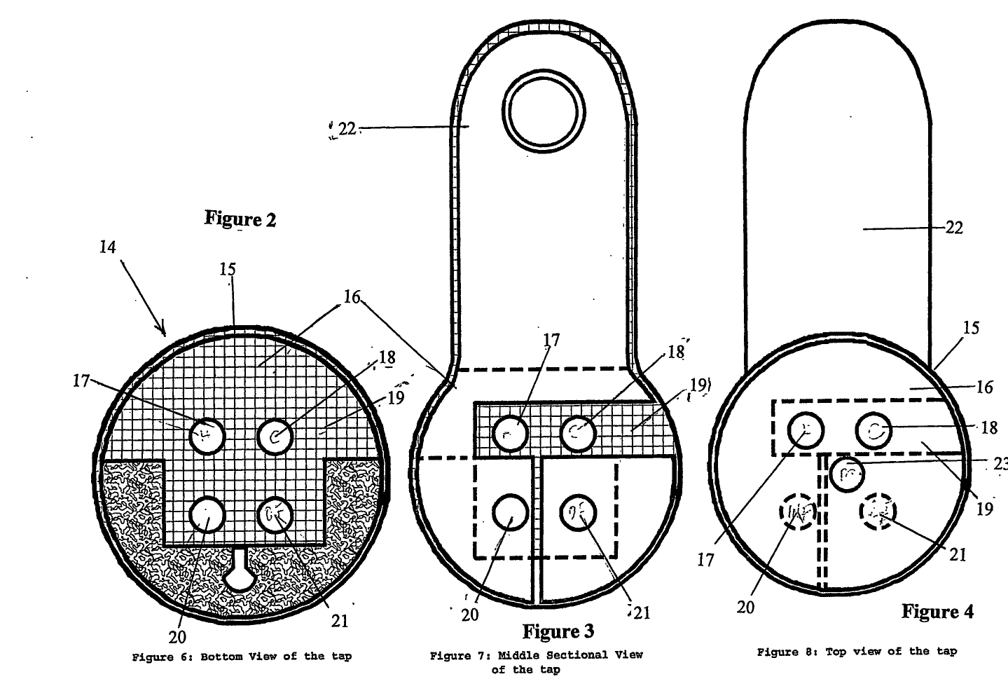

FIG. 2 shows a bottom view of a faucet assembly used in conjunction with the schematic filter assembly of FIG. 1 according to a preferred embodiment

FIG. 3 shows a middle cross section view of the faucet assembly of FIG. 2.

FIG. 4 shows a top view of the tap assembly of FIG. 3.

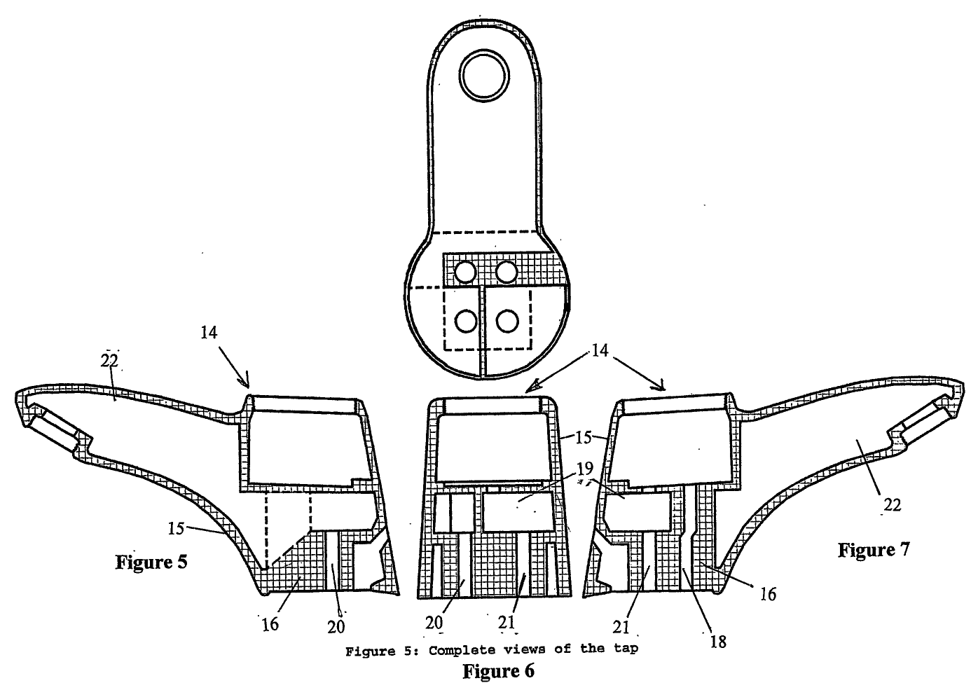

FIG. 5 shows a long sectional view of the faucet assembly for use in conjunction with the filtration assembly according to the schematic embodiment of FIG. 1.

FIG. 6 shows a rear long sectional view of the faucet assembly of FIG. 5.

FIG. 7 shows a long sectional view through the faucet of FIG. 5

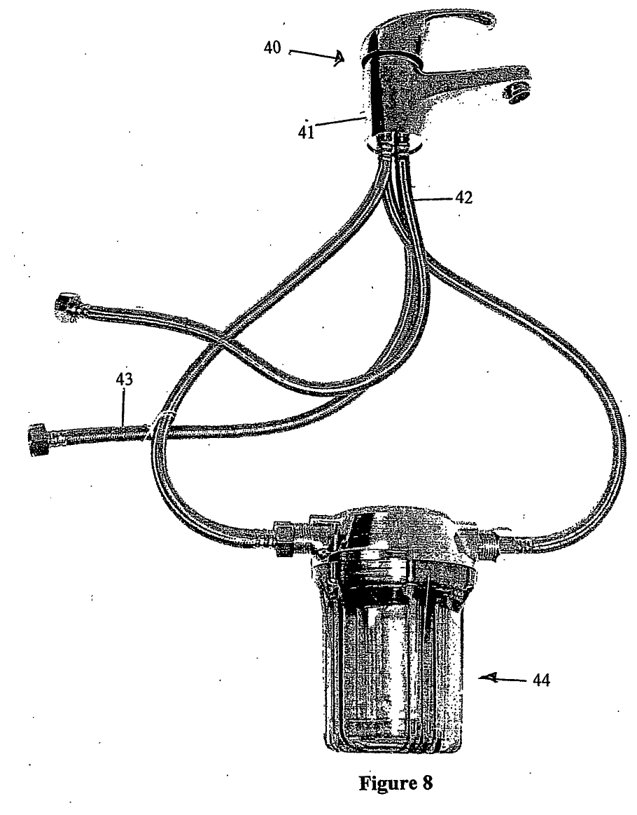

FIG. 8 shows a faucet and filter assembly fully connected.

Referring to FIG. 1 there is shown an elevated schematic view of a filtration assembly 1 according to a preferred embodiment. Assembly 1 comprises a mixing faucet 2 and adapted thereto a water reticulation network 3 which enables mixing of two inlet water streams 4 and 5. Faucet 2 is a typical known mixing tap comprising a swivel handle 6 which controls discharge of water from outlet 7a via spout 7. Handle 6 operates by selective lifting and swivelling to adjust water supply to the faucet and rate of discharge from spout 7a. Faucet body 8 defines an internal space which receives inlet cold water stream 4 and inlet hot water stream 5 which terminate in a mixing chamber 9. Mixing chamber 9 is controlled by faucet swivel handle 6. Once hot and cold water is mixed the mixed water is discharged from mixing chamber 9 into mixed water line 10. Mixed water line 10 is interrupted by an in line filter assembly 11 which filters mixed water and allows the mixed water to return via outlet line 12 which eventually discharges mixed and filtered water from spout 7 via outlet 7a. Spindle 13 controls the initial mixing of hot and cold water in mixing chamber 9. According to the prior art in line filters are used in single water lines but the prior art does not teach the use of an in line filter which filters mixed water and discharges this to a mixing faucet. An advantage of the present invention is that both hot and cold water may be filtered at once and downstream of mixing chamber 9. This allows the use of only one filter rather than two which would be the case in the event of in line filtration for both hot and cold water. Thus there is a cost and space saving by the use of one filter. Also the filter may be placed in an outlet line conveying mixed water.

FIG. 2 shows a bottom view of a faucet assembly 14 according to one embodiment used in conjunction with the schematic filter assembly of FIG. 1 according to a preferred embodiment. Faucet assembly 14 includes a faucet body 15 defining an internal space 16. Internal space 16 includes a cold water inlet pipe 17 and a hot water inlet pipe 18 both of which terminate in a mixing chamber 19. Faucet assembly 14 further comprises an inlet line 20 which communicates with a filter assembly (see FIG. 8). Inlet line 20 receives filtered water from the filter assembly following filtration and in transit towards outlet 22. Faucet assembly also receives outlet line 21 which takes water from mixing chamber 19 to the filter assembly.

FIG. 3 shows a middle cross section view of the faucet assembly 14 of FIG. 2. FIG. 3 shows a middle sectional view of faucet assembly 14 according to one embodiment used in conjunction with the schematic filter assembly of FIG. 1 according to a preferred embodiment Faucet assembly 14 includes a faucet body 15 defining an internal space 16. Internal space 16 includes a cold water inlet pipe 17 and a hot water inlet pipe 18 both of which terminate in a mixing chamber 19. As shown, faucet assembly 14 further comprises an inlet line 20 which receives filtered water from a filter assembly (see FIG. 8). Faucet assembly also receives outlet line 21 which carries water exiting the mixing chamber 19 to the filter assembly.

FIG. 4 shows a top view of the faucet assembly of FIG. 3 with corresponding numbering. Faucet assembly 14 includes in internal space 16 of faucet body 15 a mixing pipe 23. Mixing pipe 23 also communicates with a mixing chamber 19 which receives cold water inlet pipe 17 and a hot water inlet pipe 18 both of which terminate in mixing chamber 19 where mixing of hot and cold water takes place.

FIG. 5 shows a long sectional view of the faucet assembly 14 for use in conjunction with the filtration assembly according to the schematic embodiment of FIG. 1. Faucet assembly 14 includes a faucet body 15 defining an internal space 16. Internal space 16 includes an inlet line 20 which communicates with a filter assembly (see FIG. 8). Inlet line 20 which receives filtered water from the filter assembly following filtration and in transit towards outlet 22.

FIG. 6 shows a rear cross sectional elevation view of the faucet assembly of FIG. 5 and FIG. 7 shows a long sectional view through the faucet of FIG. 5. As shown in FIG. 6. Faucet assembly 14 includes an inlet line 20 which communicates with a filter assembly (see FIG. 8). Inlet line 20 receives filtered water from the filter assembly following filtration and in transit towards outlet 22. Faucet assembly also receives outlet line 21 which takes water from mixing chamber 19 to the filter assembly. FIG. 7 shows faucet assembly 14 as shown in FIG. 6 rotated 90 degrees.

FIG. 7 shows a long sectional elevation view of a faucet assembly 14 according to one embodiment used in conjunction with the schematic filter assembly of FIG. 1 according to a preferred embodiment Faucet assembly 14 includes a faucet body 15 defining an internal space 16. Internal space 16 includes a cold water inlet pipe (obscured) and a hot water inlet pipe 18 both of which terminate in a mixing chamber 19. Faucet assembly also receives outlet line 21 which takes water from mixing chamber 19 to the filter assembly.

FIG. 8 shows a faucet and filter assembly fully connected.

FIG. 8 shows a bottom view of a faucet assembly 40 according to one embodiment used in conjunction with the schematic filter assembly 44 according to a preferred embodiment. Faucet assembly 40 includes a faucet body 41 defining an internal space which receives cold water inlet pipe 42 and a hot water inlet pipe 43 both of which terminate in a mixing chamber (not shown) located inside faucet body 41. Faucet assembly 40 further comprises an outlet line 44 which communicates with filter assembly 41. Inlet line 45 communicates between filter assembly 41 and faucet assembly 40 and delivers filtered water from filter assembly 41 following filtration and in transit towards outlet spout 46 of faucet assembly 40.

It will be recognised by persons skilled in the art that numerous variations and modifications may be made to the invention as broadly described herein without departing from the overall spirit and scope of the invention.

1. An assembly enabling filtration of mixed hot and cold water; the assembly including;
a faucet capable of receiving hot and cold water and discharging mixed hot and cold water through an outlet in the faucet,
control means for operating the faucet;
a filter assembly adapted for insertion in a water supply line in which water to be filtered flows;
at least a first conduit having a supply of water and in communication with a mixing chamber disposed in said faucet,
a first outlet line from said mixing chamber communicating with the filter assembly and which delivers mixed water to said filter assembly,
an outlet line from said filter assembly communicating with said mixing faucet;
wherein mixed water exiting from the mixing chamber is filtered by said filter assembly upstream of said faucet and prior to discharge of mixed water from said outlet of said faucet

2. An assembly according to claim 1 further comprising at least a second conduit having a supply of water and which is in communication with the chamber disposed in said faucet, wherein the first and second conduits respectively deliver hot and/or cold water to said chamber in said faucet.

3. An assembly according to claim 2 wherein the chamber of the, faucet includes respective inlets for each said first and second conduits.

4. An assembly according to claim 3 wherein, hot water from one said first or second line and cold water from said first or second line are mixed in said chamber.

5. An assembly according to claim 4 wherein the mixing chamber includes an outlet in communication with the filter assembly.

6. An assembly according to claim 5 wherein the outlet communicates with said filter assembly via a conduit.

7. An assembly according to claim 6 wherein the filter assembly includes an inlet which receives water from said mixing chamber in said faucet.

8. An assembly according to claim 7 wherein the filter assembly is arranged to allow filtration in said filter assembly of hot or cold or mixed hot and cold water from the mixing chamber.

9. An assembly according to claim 8 wherein the filter assembly is disposed between the mixing chamber and the outlet of said faucet.

10. An assembly according to claim 9 wherein the filter assembly further comprises an outlet through which filtered water passes in transit to said outlet of said faucet.

11. An assembly according to claim 10 wherein, the faucet includes a spout for dispensing mixed, filtered water from an orifice.

12. An assembly according to claim 11 wherein, a valve allows the faucet to switch between delivery of hot and cold water or mixed hot and cold water, wherein the valve includes a valve body having an input channel means for receiving each of said hot water or said cold water or mixed hot and cold water.

13. An assembly according to claim 12 wherein the filter assembly comprises a filter housing defining a cavity therein, and a filter cartridge disposed inside the housing and a closure for sealing the cavity.

14. An assembly according to claim 13 wherein the closure comprises a removable housing end cap allowing insertion and replacement of a filter cartridge in said housing.

15. An assembly according to claim 14 wherein, the faucet assembly includes a single adjustable valve means and adjusting lever means to regulate the flow of filtered water therefrom.

16. An assembly according to claim 15 wherein, the filter assembly housing includes at least two filters.

17. An assembly according to claim 16 wherein there are at least two filter assemblies in series.

18. A mixing faucet and filter assembly, comprising:
a faucet body having therein a mixing chamber capable of receiving cold water and hot water, said faucet body including at least two inlet lines in communication with the chamber;
at least one outlet line from the mixing chamber in communication with at least one filter assembly disposed in the outlet line; wherein water mixed in the mixing chamber passes through the at least one filter prior to discharge of said-mixed water from an outlet-to the faucet;

19. An assembly according to claim 18 wherein there are multiple outlet lines carrying mixed hot and cold water emanating from the mixing chamber.

20. An assembly according to claim 19 wherein, the faucet includes a mounting means which allows the faucet to be affixed to a rear deck of a sink.

21. An assembly enabling filtration of mixed hot and cold water; the assembly including;
a faucet having control means for operating the faucet, an inlet for receiving mixed water an outlet for discharging mixed water;
a mixing chamber which receives at least two water streams from at least one water source,
an outlet to said mixing chamber for discharging water mixed from said at least two water streams,
a filter assembly adapted for insertion in at least one water line in communication with said outlet from the mixing chamber;
an outlet line from said filter assembly communicating with said mixing faucet; whereupon water exiting said filter assembly travels via said water line from the filter assembly to said outlet of said mixing faucet.

22. An assembly according to claim 21 wherein the first and second conduits respectively deliver hot and/or cold water to said mixing chamber in said faucet; wherein the chamber of the faucet includes respective inlets for each said first and second conduits.

23. A mixing faucet and filter arrangement, comprising:
a faucet body having a mixing chamber capable of receiving cold water and hot water therein, said body having a lower end which receives at least two inlet lines in communication with the mixing chamber;
at least one outlet line from the mixing chamber in communication with at least one filter assembly disposed in the outlet line; wherein water mixed in the mixing chamber passes through the at least one filter before exiting from said mixing faucet.

24. A method of filtering water delivered to a mixing faucet from a water supply, using an assembly including a mixing faucet having a faucet and a mixing chamber capable of receiving cold and hot water therein, said faucet body having a lower end which receives at least two inlet lines in communication with the mixing chamber and which deliver water to the chamber;
the method comprising the steps of:
a) taking at least one filter assembly and placing the at least one filter assembly in a water supply line capable of delivering mixed hot and cold water from the mixing chamber of the faucet;
b) allowing water mixed in said mixing chamber to pass through the at least one filter assembly;
c) allowing mixed hot and cold water to exit the at least one filter assembly so that water passing through the filter is hot and/or cold water so that any water discharged from the faucet is filtered.
